(19) United States
(12) Patent Application Publication
(10) Pub. No.: US 2008/0244031 A1
(43) Pub. Date: Oct. 2, 2008

(54) On-Demand Memory Sharing

(76) Inventors: Devesh Kumar Rai, Beaverton, OR (US); Venkateswararao Jujjuri, Beaverton, OR (US)

Correspondence Address: CENTURY IP GROUP, INC. [IBM US], P.O. BOX 7333, NEWPORT BEACH, CA, 92658-7333, US

(21) Appl. No.: 11/695,000

(22) Filed: Mar. 31, 2007

(51) Int. Cl. G06F 15/167

(52) U.S. Cl. 709/213

(57) ABSTRACT

A method for sharing memory resources in a data network is provided. The method comprises monitoring first memory space available to a first system; transferring data to a second system, in response to determining that the first memory space has fallen below a first threshold level; and transferring instructions to the second system to perform a first operation on the data.

### COPYRIGHT & TRADEMARK NOTICES

A portion of the disclosure of this patent document contains material, which is subject to copyright protection. The owner has no objection to the facsimile reproduction by any one of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is for providing an enabling disclosure by way of example and shall not be construed to limit the scope of this invention to material associated with such marks.

### FIELD OF INVENTION

The present invention relates generally to computing environments and, more particularly, to a system and method for sharing memory resources in a data network.

### BACKGROUND

In a networked computing environment, pluralities of computing systems are interconnected for the purpose of exchanging data and sharing resources. Two computing systems in the same network are typically able to read from or write to a shared disk drive. The shared disk drive may be locally or remotely attached to the computing systems. Thus, one advantage of a data network is access to shared resources.

Unfortunately, in the current networked environments, a first computing system may not be able to access memory space that may be locally available to a second computing system. For example, if the first computing system reaches a critical state in which only a limited amount of local memory space remains available, the first computing system cannot use the free memory space locally available to a second computer in the network.

Thus, despite of the availability of memory on a remote computing system, the first computing system may run out of memory. It is desirable for the networked computing systems to share resources that are available to them either locally or remotely. As such, methods and systems are needed that can allow a computing system to remotely access memory resources that are locally available to the other computing systems in the network.

### SUMMARY

The present disclosure is directed to a system and corresponding methods that facilitate on-demand memory sharing among interconnected computing systems.

In accordance with one embodiment, a method for sharing memory resources in a data network is provided. The method comprises monitoring first memory space available to a first system; transferring data to a second system, in response to determining that the first memory space has fallen below a first threshold level; and transferring instructions to the second system to perform a first operation on the data.

In certain embodiments, the first operation is performed on the data, in response to determining that the second system was unable to store the data in the second memory space or in response to the second system failing to perform the first operation successfully. A copy of the data may be removed from the first memory space, in response to determining that the second system has successfully performed the first operation.

In another embodiment, a computer program product comprising a computer useable medium having a computer readable program is provided. The computer readable program when executed on a computer causes the computer to perform the operations associated with the methods disclosed above for sharing memory resources in a data network.

In yet another embodiment, a system for sharing memory resources in a data network is provided. The system comprises one or more logic units for performing the operations associated with the methods disclosed above.

One or more of the above-disclosed embodiments in addition to certain alternatives are provided in further detail below with reference to the attached figures. The invention is not, however, limited to any particular embodiment disclosed.

### BRIEF DESCRIPTION OF THE DRAWINGS

Embodiments of the present invention are understood by referring to the figures in the attached drawings, as provided below.

FIG. 1 illustrates an exemplary computing environment in accordance with one or more embodiments, wherein a plurality of computing systems can share networked resources.

FIGS. 2 and 3 are flow diagrams of exemplary methods for sharing memory resources among a plurality of computing systems in a network, in accordance with one embodiment.

FIGS. 4A and 4B are block diagrams of hardware and software environments in which a system of the present invention may operate, in accordance with one or more embodiments.

Features, elements, and aspects of the invention that are referenced by the same numerals in different figures represent the same, equivalent, or similar features, elements, or aspects, in accordance with one or more embodiments.

### DETAILED DESCRIPTION OF EXEMPLARY EMBODIMENTS

The present disclosure is directed to systems and corresponding methods that facilitate sharing memory resources in a data network. The method comprises monitoring first memory space available to a first system; transferring data to a second system, in response to determining that the first memory space has fallen below a first threshold level; and transferring instructions to the second system to perform a first operation on the data.

In the following, specific details are set forth to provide a thorough description of various embodiments of the invention. Certain embodiments of the invention may be practiced without these specific details or with some variations in detail. In some instances, certain features are described in less detail so as not to obscure other aspects of the invention. The level of detail associated with each of the elements or features should not be construed to qualify the novelty or importance of one feature over the others.

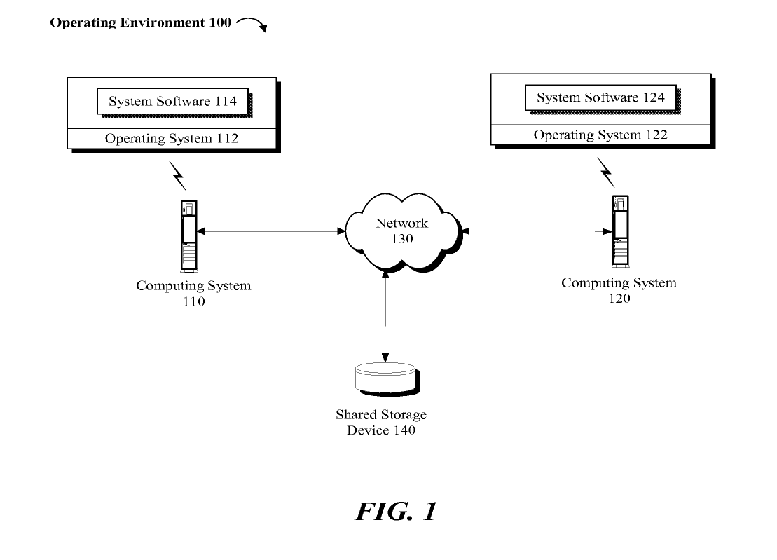

Referring to FIG. 1, an exemplary operating environment 100 is illustrated, wherein computing system 110 is interconnected with computing system 120 in a data network 130. Network 130 is configured to allow computing systems 110 and 120 exchange data and access shared resources (e.g., shared storage device 140) connected to network 130.

Operating systems 112 and 122 respectively control the general operation of computing systems 110 and 120. System software 114 and 124 are respectively executed on top of each operating system 112 and 122 to allow computing systems 110 and 120 to share resources.

In the following, exemplary embodiments of the invention are disclosed as applicable to system software 112 and 122 that allow computing systems 110 and 120 share local memory resources with other computing systems in network 130. It is noteworthy, however, that the system software 112 and 122 in other embodiments can be utilized to facilitate sharing of other local or remote resources with other computing systems in network 130.

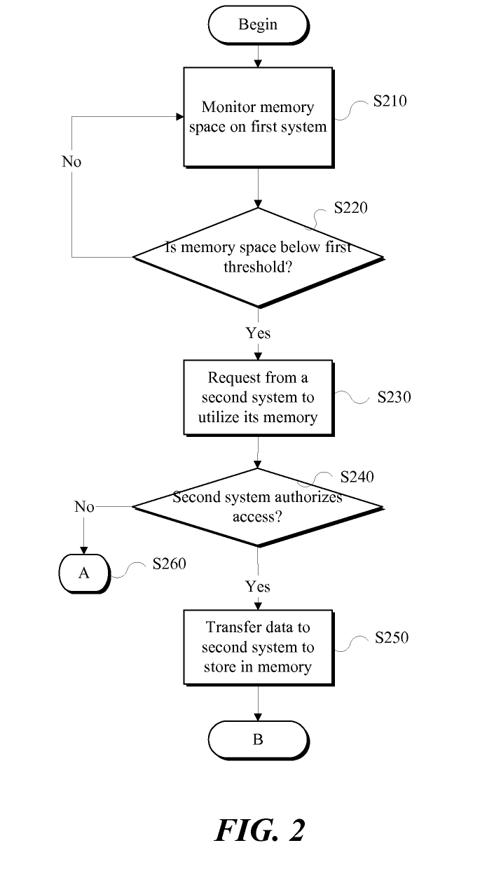

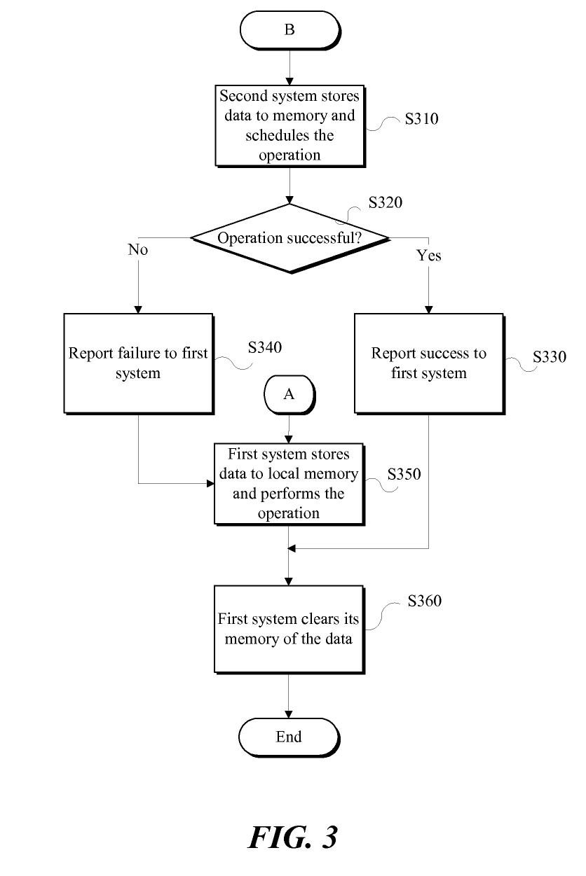

FIGS. 2 and 3 illustrate a method for monitoring memory space in a networked computing system. As shown, part of the method shown in FIG. 2 may be performed by computing system 110 and part of the method shown in FIG. 3 may be performed in computing system 120.

Referring to FIG. 2, system software 114 is executed on computing system 110 to monitor memory space available to computing system 110. Depending on the type and number of operations performed by computing system 110, the amount of memory available to computing system 110 changes. Since some operations (e.g., video recording) are highly memory intensive and computing system 110 has a finite amount of local memory available to it, there is a chance that the entire or a great portion of the available memory space to computing system 110 can be consumed while computing system 110 is performing said operations.

It is undesirable for computing system 110 to operate using the maximum amount of local memory available to it. Under such conditions the likelihood for computing system 110 to operate in an unreliable manner (e.g., crash) increases because computing system 110 may not have sufficient memory space to support the code being executed. Operating under such conditions also reduces the throughput of the entire system, especially where the memory space is utilized as a temporary storage area (i.e., cache) for the purpose of storing and accessing frequently needed data.

In accordance with one aspect of the invention, system software 114 monitors computing system 110's memory space (S210). System software 114 is configured to determine when the memory space available to computing system 110 falls below a certain threshold (S220). As an example, computing system 110 may be utilized for the purpose of recording video data to shared storage device 140 (e.g., a hard drive). Video data is captured at a higher speed than it is possible to write the captured data to a storage medium, such as a hard drive.

To maintain a high recording speed, computing system 110 may load the captured data into cache memory in a first speed, and write the data onto shared storage device 140 (e.g., hard drive) in a second speed. In this manner data is recorded at a higher speed because a write operation to cache memory is faster than a write operation to a hard drive. Thus, so long as the cache memory is not full, the recording speed is equal to the speed at which the data is loaded into the cache memory that is locally available to computing system 110.

In the above example, once the local memory available to computing system 110 is full or reaches a certain threshold, the recording will slow down to the speed of the write operation to the shared storage device 140. The reason for this slow down in recording speed is that once local memory is full, memory space becomes available at the speed with which data is written to the hard drive, as the data written to the hard drive is cleared from local memory.

Advantageously, in accordance with one embodiment, in order to avoid a slow down in the recording operation, once system software 114 determines that the local memory space for the computing system 110 is below a first threshold level, system software 114 requests from another networked device, such as computing system 120, to utilize that device's local memory for the purpose of caching data (S230).

In one embodiment, system software 124 executing on computing system 120 determines whether computing system 120 can authorize computing system 110 to access the local memory available to computing system 120 (S240). If so, then system software 114 transfers some of the data that cannot be stored in computing system 110's memory to be stored in computing system 120's memory (S250). If access is not authorized, then computing system 110 writes the data that was to be transferred to computing system 120's local memory to its local memory as such memory space becomes available (S260).

If computing system 120 grants authorization for the use of its local memory by computing system 110 (S240), computing system 120 receives the data transferred to it by system software 114. In certain embodiments, in addition to the data, system software 114 also transfers instructions to computing system 120 about what operation or operations are to be performed on the data. In the above example, where the data is video data, the instructions may be for computing device 120 to store the data to the shared storage device 140.

Depending on implementations, additional information on how to synchronize the write operation may be also provided. For example, system software 114 may process certain metadata and transfer such information to computing system 120 to indicate the location in which the transferred data should be written on the shared storage device 140. Other types of information regarding the nature of the operation or the identity of the transferred data may be also transferred.

Referring to FIG. 3, once the data and preferably the instructions are successfully transferred, system software 124 running on computing system 120 causes the received data to be stored in computing system 120's local memory, for example, and schedules for the instructed operations to be performed on the data stored in computing system 120's local memory (S310). In the above example, system software 124 may schedule a write operation to shared storage device 140.

In one embodiment, system software 124 reports the successful storage of the data in computing system 120's local memory (and preferably the fact that the requested operation has been scheduled) to computing system 110 promptly. In this manner, computing system 110 can quickly clear its local memory from the transferred data to provide room for new data being received by computing system 110.

In certain embodiments, system software 124 determines whether the scheduled operation has been successful (S320). If so, then system software 124 reports the successful notice to computing system 110 (S330); otherwise, a failure notice is forwarded to computing system 110 (S340). When the operation is unsuccessful, system software 114 may request that computing system 120 or another computing system (not shown) in network 130 perform the operation again until success is achieved.

In an alternative embodiment, when a failure notice is received (or when access to local memory of computing system 120 is not authorized), system software 114 stores the data that was transferred to computing system 120 to computing system 110's local memory and causes computing system 110 to perform the operation (S350). As noted earlier, to avoid the risk of data loss, the data that is transferred to computing system 120 may be also stored in computing system 110's local memory, prior to the data being transferred, until a successful notice is received.

Thus, in one embodiment, a successful notice is generated by the second computing system 120 when the requested operation is scheduled to be performed by the second computing system 120. That is, the memory in the first computing system 110 is used to store the data for the short period of time in which the operation is scheduled for execution on the second computing system 120, in contrast to a longer period of time that may take for the operation to be scheduled and performed by the second computing system 120.

In the latter scenario, system software 114 would not need to write the data to computing system 110's local memory in case of a failure, as the data is already in computing system 110's local memory. Accordingly, when a successful notice is received (e.g., when the data is successfully written to shared storage device 140), system software 114 causes computing system 110's memory to be cleared of the data, as the data is no longer needed.

In yet another embodiment, system software 114 or system software 124 may set a time threshold for the successful completion of the scheduled operation that computing system 120 is to perform. Accordingly, if a successful notice is not received by the expiration of the time threshold, then system software 114 causes computing system 110 to perform the operation.

It is noteworthy, that system software 114 and 124 in other embodiments may be executed fully or partially on an independent computing system (e.g., a network server) instead of on computing systems 110 or 120. That is, in certain embodiments, a network server may be implemented to perform one or more of the aforementioned operations attributed to system software 114 and 124.

Further more, one of ordinary skill would appreciate that while the present disclosure by way of example has been described as applicable to a data write operation, the conventions and principals discussed herein can be equally applied to other operations or procedures in a computing environment. Examples of such operations are a read operation or any other operation that can be performed on data stored in memory.

In different embodiments, the invention can be implemented either entirely in the form of hardware or entirely in the form of software, or a combination of both hardware and software elements. For example, computing systems 110, 120 and system software 114, 124 may comprise a controlled computing system environment that can be presented largely in terms of hardware components and software code executed to perform processes that achieve the results contemplated by the system of the present invention.

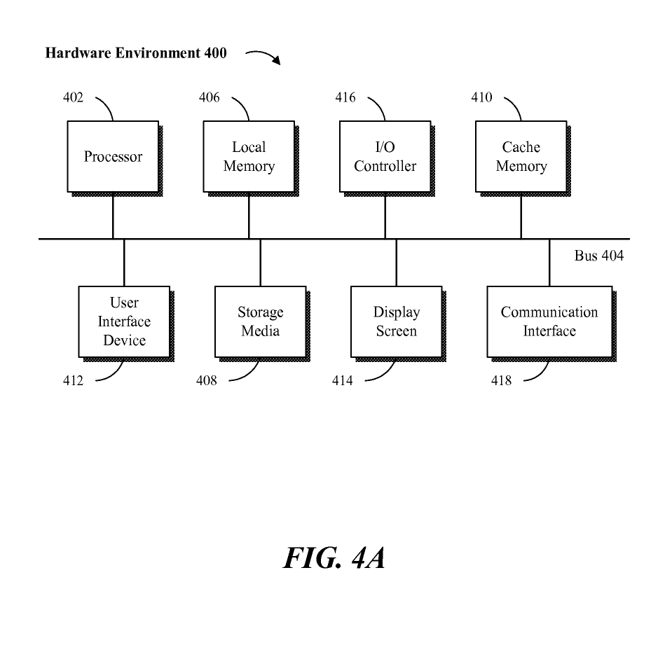

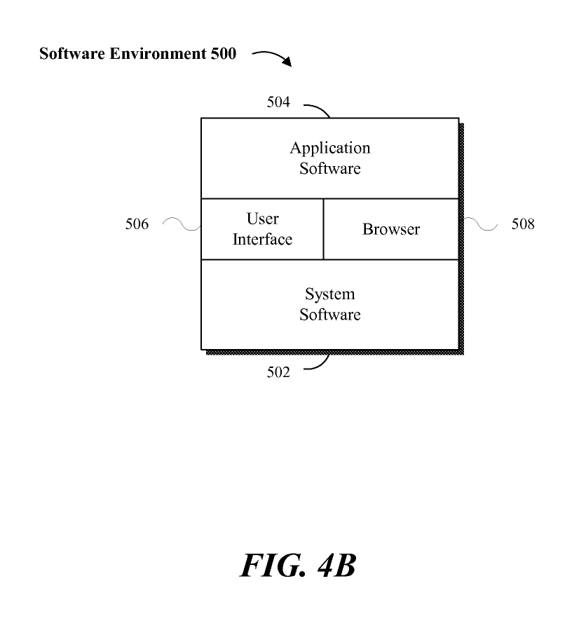

Referring to FIGS. 4A and 4B, a computing system environment in accordance with an exemplary embodiment is composed of a hardware environment 400 and a software environment 500. The hardware environment 400 comprises the machinery and equipment that provide an execution environment for the software; and the software provides the execution instructions for the hardware as provided below.

As provided here, the software elements that are executed on the illustrated hardware elements are described in terms of specific logical/functional relationships. It should be noted, however, that the respective methods implemented in software may be also implemented in hardware by way of configured and programmed processors, ASICs (application specific integrated circuits), FPGAs (Field Programmable Gate Arrays) and DSPs (digital signal processors), for example.

Software environment 500 is divided into two major classes comprising system software 502 and application software 504. System software 502 comprises control programs, such as the operating system (OS) and information management systems that instruct the hardware how to function and process information.

In a preferred embodiment, system software 114, 124 may be implemented as system software 502 executed on one or more hardware environments to facilitate memory sharing among computing systems in network 130. Application software 504 may comprise but is not limited to program code, data structures, firmware, resident software, microcode or any other form of information or routine that may be read, analyzed or executed by a microcontroller.

In an alternative embodiment, the invention may be implemented as computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate or transport the program for use by or in connection with the instruction execution system, apparatus or device.

The computer-readable medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random access memory (RAM), a read-only memory (ROM), a rigid magnetic disk and an optical disk. Current examples of optical disks include compact disk read only memory (CD-ROM), compact disk read/write (CD-R/W) and digital videodisk (DVD).

Referring to FIG. 4A, an embodiment of the system software 502 can be implemented as computer software in the form of computer readable code executed on a data processing system such as hardware environment 400 that comprises a processor 402 coupled to one or more computer readable media or memory elements by way of a system bus 404. The computer readable media or the memory elements, for example, can comprise local memory 406, storage media 408, and cache memory 410. Processor 402 loads executable code from storage media 408 to local memory 406. Cache memory 410 provides temporary storage to reduce the number of times code is loaded from storage media 408 for execution.

A user interface device 412 (e.g., keyboard, pointing device, etc.) and a display screen 414 can be coupled to the computing system either directly or through an intervening I/O controller 416, for example. A communication interface unit 418, such as a network adapter, may be also coupled to the computing system to enable the data processing system to communicate with other data processing systems or remote printers or storage devices through intervening private or public networks. Wired or wireless modems and Ethernet cards are a few of the exemplary types of network adapters.

In one or more embodiments, hardware environment 400 may not include all the above components, or may comprise other components for additional functionality or utility. For example, hardware environment 400 may be a laptop computer or other portable computing device embodied in an embedded system such as a set-top box, a personal data assistant (PDA), a mobile communication unit (e.g., a wireless phone), or other similar hardware platforms that have information processing and/or data storage and communication capabilities.

In certain embodiments of the system, communication interface 418 communicates with other systems by sending and receiving electrical, electromagnetic or optical signals that carry digital data streams representing various types of information including program code. The communication may be established by way of a remote network (e.g., the Internet), or alternatively by way of transmission over a carrier wave.

Referring to FIG. 4B, system software 502 can comprise one or more computer programs that are executed on top of operating system 112 after being loaded from storage media 408 into local memory 406. In a client-server architecture, application software 504 may comprise client software and server software. For example, in one embodiment of the invention, client software is executed on computing systems 110 or 120 and server software is executed on a server system (not shown).

Software environment 500 may also comprise browser software 508 for accessing data available over local or remote computing networks. Further, software environment 500 may comprise a user interface 506 (e.g., a Graphical User Interface (GUI)) for receiving user commands and data. Please note that the hardware and software architectures and environments described above are for purposes of example, and one or more embodiments of the invention may be implemented over any type of system architecture or processing environment.

It should also be understood that the logic code, programs, modules, processes, methods and the order in which the respective steps of each method are performed are purely exemplary. Depending on implementation, the steps may be performed in any order or in parallel, unless indicated otherwise in the present disclosure. Further, the logic code is not related, or limited to any particular programming language, and may comprise of one or more modules that execute on one or more processors in a distributed, non-distributed or multiprocessing environment.

Therefore, it should be understood that the invention can be practiced with modification and alteration within the spirit and scope of the appended claims. The description is not intended to be exhaustive or to limit the invention to the precise form disclosed. These and various other adaptations and combinations of the embodiments disclosed are within the scope of the invention and are further defined by the claims and their full scope of equivalents.

What is claimed is:

1. A method for sharing memory resources in a data network, the method comprising:
monitoring a first memory space available to a first system;
transferring data to a second system, in response to determining that the first memory space has fallen below a first threshold level; and
transferring instructions to the second system to perform a first operation on the data.

2. The method of claim 1, wherein the first memory space is local to the first system.

3. The method of claim 1, wherein the data is stored in the first memory space prior to transferring the data to the second system.

4. The method of claim 1, wherein the data is stored in a second memory space available to the second system, the method further comprising performing the first operation on the data by the first system, in response to determining that the second system was unable to store the data in the second memory space.

5. The method of claim 3, further comprising performing the first operation on the data stored in the first memory space, in response to the second system failing to perform the first operation successfully.

6. The method of claim 3, further comprising clearing a copy of the data from the first memory space, in response to determining that the second system has successfully performed the first operation.

7. The method of claim 5, further comprising determining that the second system has failed to perform the first operation, when a threshold time period expires before receiving confirmation that the first operation has been performed by the second system.

8. The method of claim 1, wherein the first operation comprises scheduling a second operation to be performed on the data.

9. The method of claim 8, wherein the second operation comprises a write operation or a read operation directed to a disk drive accessible by both the first system and the second system.

10. A system for sharing memory resources in a data network, the system comprising:
a logic unit for monitoring a first memory space available to a first system;
a logic unit for transferring data to a second system, in response to determining that the first memory space has fallen below a first threshold level; and
a logic unit for transferring instructions to the second system to perform a first operation on the data.

11. The system of claim 10, further comprising a logic unit for performing the first operation on the data, in response to determining that the second system was unable to store the data in the second memory space.

13. The system of claim 11, further comprising a logic unit for determining that the second system has failed to perform the first operation, when a threshold period expires before receiving confirmation that the first operation has been performed.

14. The system of claim 10, wherein the first operation comprises scheduling a second operation to be performed on the data.

15. The method of claim 14, wherein the second operation comprises a write operation or a read operation directed to a disk drive accessible by both the first system and the second system.

16. A computer program product comprising a computer useable medium having a computer readable program, wherein the computer readable program when executed on a computer causes the computer to:
receive data transferred from a first system, in response to determining that a first memory space available to the first system has fallen below a first threshold level; and
receive instructions from the first system for a second system to perform a first operation on the data.

17. The computer program product of claim 16, wherein the first memory space is local to the first system.

18. The computer program product of claim 17, wherein the data is stored in the first memory space prior to transferring the data to the second system.

19. The computer program product method of claim 18, wherein the first system performs the first operation on the data, in response to determining that the second system was unable to store the data in the second memory space or schedule the first operation to be performed on the data.
